(19) United States
(12) Patent Application Publication
(10) Pub. No.: US 2024/0372366 A1
(43) Pub. Date: Nov. 7, 2024

(54) LOW-VOLTAGE USER INTELLIGENT INTERACTION RESPONSE EXCHANGE SYSTEM AND METHOD

(71) Applicants: GUANGXI POWER GRID CO., LTD., Nanning, Guangxi (CN); ELECTRIC POWER RESEARCH INSTITUTE, CHINA SOUTHERN POWER GRID, Guangzhou, Guangdong (CN)

(72) Inventors: Wenqian JIANG, Nanning, Guangxi (CN); Bin QIAN, Guangzhou, Guangdong (CN); Xiuqing LIN, Nanning, Guangxi (CN); Kun ZHANG, Nanning, Guangxi (CN); Zhou YANG, Nanning, Guangxi (CN); Jun CHEN, Nanning, Guangxi (CN); Keying HUANG, Nanning, Guangxi (CN); Jianlin TANG, Guangzhou, Guangdong (CN); Jueyu CHEN, Nanning, Guangxi (CN); Junli HUANG, Nanning, Guangxi (CN); Fan ZHANG, Guangzhou, Guangdong (CN); Zhitao TANG, Nanning, Guangxi (CN); Daiyuan BAO, Nanning, Guangxi (CN); Dandan YAN, Nanning, Guangxi (CN)

(73) Assignees: GUANGXI POWER GRID CO., LTD., Nanning, Guangxi (CN); ELECTRIC POWER RESEARCH INSTITUTE, CHINA SOUTHERN POWER GRID, Guangzhou, Guangdong (CN)

(21) Appl. No.: 18/562,867

(22) PCT Filed: Aug. 19, 2022
(86) PCT No.: PCT/CN2022/113585

§ 371 Date: Nov. 21, 2023

(30) Foreign Application Priority Data
Mar. 14, 2022 (CN) 202210245141.4

(51) Int. Cl. H02J 3/14; H02J 13/00

(52) U.S. Cl. CPC H02J 3/144; H02J 13/00001; H02J 13/00002; H02J 13/00004; H02J 13/00024

(57) ABSTRACT

A response interaction system for intelligently interacting with a low-voltage user includes: a distribution network and system master station, an intelligent electric meter, a mobile APP, an intelligent interaction terminal, an intelligent gateway, and a low-voltage user load. In the process of the low-voltage user participating in the demand response, the distribution network and system master station publishes a demand response plan and a demand response notification through the mobile APP, the low-voltage user receives the demand response plan and the demand response notification through the mobile APP, the low-voltage user is connected to the intelligent interaction terminal through the mobile APP and controls a load to operate or not operate through the intelligent gateway, to perform the demand response task.

The present application claims priority to Chinese Patent Application No. 202210245141.4, titled “LOW-VOLTAGE USER INTELLIGENT INTERACTION RESPONSE EXCHANGE SYSTEM AND METHOD”, filed on Mar. 14, 2022 with the Chinese Patent Office, which is incorporated herein by reference in its entirety.

### FIELD

The present disclosure relates to the field of demand response of low-voltage users, and in particular to a response interaction system for intelligently interacting with a low-voltage user and a response interaction method for intelligently interacting with a low-voltage user.

### BACKGROUND

Demand response is an important way to improve flexibility of a power system, facilitating realizing the dual-carbon target and constructing a new type of power system. According to the conventional technology, users that participate in the demand response are only industrial users. With the development of Internet of Things technology, residential loads may participate in the demand response. Residential loads are high-quality and flexible adjustable resources, so that participation of the residential loads in low-voltage demand response is conducive to increasing the users participating the demand response and further improving the total amount of available scheduling resources.

Based on an incentive pattern of affecting a load, the demand response may include a price-based demand response and an incentive-based demand response. For the price-based demand response, an end power consumer is guided to independently adjust electricity consumption and electricity consumption time based on a price signal. For the incentive-based demand response, the end power consumer is encouraged to reduce a load through economic compensation and electricity price rebates. Based on the demand response, adjustability of a load side of the power system can be significantly improved, thereby improving the operation efficiency of the power system, optimizing investment and construction, enhancing the new energy consumption capacity, and flattening the load curve.

Currently, power grid corporations eagerly hope that the low-voltage users participate in the demand response to enhance the energy consumption capacity, and the low-voltage users may obtain economic benefits from participating in the demand response. However, at present, the low-voltage users do not enthusiastically participate in the demand response, mainly due to the fact that it is not convenient for residential loads to participate in the low-voltage demand response. Usually, it is required for the residential user to download multiple APPs (applications) to receive demand response information. In addition, APPs released for the demand response in different regions are not the same or unified. Furthermore, after obtaining the demand response information, it is required for the residential user to perform relevant operations to realize the demand response. However, due to factors such as publicity, the residential user is prone to erroneously operate, resulting in failure of the demand response and even electricity accidents.

### SUMMARY

A response interaction system for intelligently interacting with a low-voltage user and a response interaction method for intelligently interacting with a low-voltage user are provided according to the present disclosure, to solve the problem of inconvenient and prone to misoperation for the low-voltage user in participating in power demand response according to the conventional technology.

To achieve the above objective, in a first aspect, a response interaction system for intelligently interacting with a low-voltage user is provided according to the present disclosure. The response interaction system includes: a distribution network and system master station, an intelligent electric meter, a mobile APP, an intelligent interaction terminal, an intelligent gateway, and a low-voltage user load. The distribution network and system master station, the intelligent electric meter, the low-voltage user load, the intelligent gateway, the intelligent interaction terminal, and the mobile app are wirelessly connected in sequence, and the distribution network and system master station is wirelessly connected to the mobile APP.

In an embodiment, the following information flows are transmitted in the response interaction system:
information flow 1 transmitted between the low-voltage user and the mobile APP, where the mobile APP is configured to perform a demand response invitation, a quotation and a verification, and remotely control and execute a demand response;
information flow 2 transmitted between the mobile APP and the intelligent interaction terminal, where the mobile APP is configured to transmit an execution instruction for a demand response task to the intelligent interaction terminal;
information flow 3 transmitted between the intelligent interaction terminal and the intelligent gateway, where the intelligent interaction terminal is configured to remotely control the low-voltage user load through the intelligent gateway;
information flow 4 transmitted between the intelligent gateway and the low-voltage user load, where the intelligent gateway is configured to transmit an instruction to control the low-voltage user load to operate or not operate;
information flow 5 transmitted between the low-voltage user load and the intelligent electric meter, where the intelligent electric meter is configured to acquire a state of the low-voltage user load that operates or does not operate, and then generate and transmit a message; and
information flow 6 transmitted between the intelligent electric meter and the mobile APP, where the intelligent electric meter is configured to transmit an execution result of the demand response task to the mobile APP.

In an embodiment, the distribution network and system master station and the mobile APP perform communication through a 4G/5G communication network, a private wireless network or a fiber optic private network; and the mobile APP and the intelligent interaction terminal, the intelligent interaction terminal and the intelligent gateway, and the intelligent gateway and the low-voltage user load respectively perform communication a Wi-Fi technology, a Bluetooth technology or a Zigbee technology.

In an embodiment, the distribution network and system master station and the mobile APP, the mobile APP and the intelligent interaction terminal, the intelligent interaction terminal and the intelligent gateway, and the intelligent gateway and the low-voltage user load respectively perform communication with an encryption algorithm. According to the encryption algorithm, a security protection mechanism is constructed by using an account password and a protocol encryption algorithm, an IP address, a MAC address, a spectrum, an orientation and an intensity feature of a communication link are analyzed, and a feature fingerprint of a legitimate intelligent home gateway is extracted by using a clustering analysis algorithm, to detect and identify an illegal communication link, ensuring the security of information transmission, and avoiding a large-scale power accident due to an erroneous operation on the demand response caused by network hijacking or information leakage.

In an embodiment, the mobile APP includes, but is not limited to, a “Southern Power Grid” APP and an “Intelligent Home” APP.

In an embodiment, the “Intelligent Home” APP includes, but is not limited to, “MiJia” APP and a “Huawei Smart Life” APP.

In an embodiment, the low-voltage user load includes, but is not limited to, a computer, an illuminating device, a water heater, an air conditioner, a sweeping machine, a washing machine, a dishwasher, and an electric vehicle.

In another aspect, a response interaction method for intelligently interacting with a low-voltage user is further provided according to the present disclosure. The response interaction method includes a process of the low-voltage user participating in a demand response. The process of the low-voltage user participating in the demand response includes:
step S1, transmitting, by a distribution network and system master station, a demand response plan and a demand response notification through a mobile APP (application);
step S2, receiving, by the low-voltage user, the demand response notification through the mobile APP, and acquiring, by the low-voltage user, an operation guide for performing a demand response task;
step S3, connecting the low-voltage user to an intelligent interaction terminal through the mobile APP, and transmitting, by the low-voltage user, an operation instruction related to the demand response task;
step S4, transmitting, by the intelligent interaction terminal through an intelligent gateway, an operation instruction to an intelligent circuit breaker corresponding to a load connected to the intelligent gateway to control the intelligent circuit breaker to be turned on or turned off; and
step S5, determining, by the low-voltage user through the mobile APP, an execution state of the demand response task, and performing, by the low-voltage user, the demand response task.

In an embodiment, an intelligent electric meter generates a message and transmits the message to the distribution network and system master station, the distribution network and system master station analyzing the message to acquire the execution state of the demand response task of the low-voltage user, and transmits an execution result of the demand response task through the mobile APP.

In an embodiment, the intelligent electric meter transmits the message, and communicates and interacts with the distribution network and system master station in a power line communication manner.

Compared with the conventional technology, the present disclosure has the following beneficial effects.

According to the present disclosure, in the process of the low-voltage user participating in the demand response, the distribution network and system master station publishes a demand response plan and a demand response notification through the mobile APP, the low-voltage user receives the demand response plan and the demand response notification through the mobile APP, and the low-voltage user is connected to the intelligent interaction terminal through the mobile APP and controls a load to operate or not operate through the intelligent gateway, to perform the demand response task. Thus, the demand response task is performed through the mobile APP, improving the convenience of the low-voltage user participating in the demand response, avoiding the failure of the demand response task due to the erroneous operation of the low-voltage user, and further avoiding a power accident.

### BRIEF DESCRIPTION OF THE DRAWINGS

In order to more clearly illustrate embodiments of the present disclosure, the drawings to be used in the embodiments are briefly described below. Apparently, the drawings in the following description show only some embodiments of the present disclosure, and other drawings may be obtained by those skilled in the art from the drawings without any creative work.

FIG. 1 is a block diagram of a response interaction system for intelligently interacting with a low-voltage user according to an embodiment of the present disclosure;

FIG. 2 is a flow chart of a low-voltage user participating in demand response by using a response interaction system for intelligently interacting with a low-voltage user according to an embodiment of the present disclosure; and

FIG. 3 is a schematic diagram showing information flows transmitted in a response interaction system for intelligently interacting with a low-voltage user according to an embodiment of the present disclosure.

### DETAILED DESCRIPTION OF THE EMBODIMENTS

The embodiments of the present disclosure are described in detail hereinafter with reference to the drawings.

Implementations of the present disclosure are described hereinafter through specific examples. Those skilled in the art can easily understand other advantages and effects of the present disclosure from contents disclosed in this specification. Apparently, the described embodiments are only some of the embodiments of the present disclosure, rather than all of the embodiments. The present disclosure may be implemented or applied through other different embodiments. Various details in this specification may be modified or alternated based on different viewpoints and applications, without departing from the spirit of the present disclosure. It should be noted that, the embodiments of the present disclosure and features in the embodiments may be combined with each other without causing conflicts. Based on the embodiments of the present disclosure, all other embodiments obtained by those skilled in the art without any creative effort shall fall within the scope of protection of the present disclosure.

### Embodiment

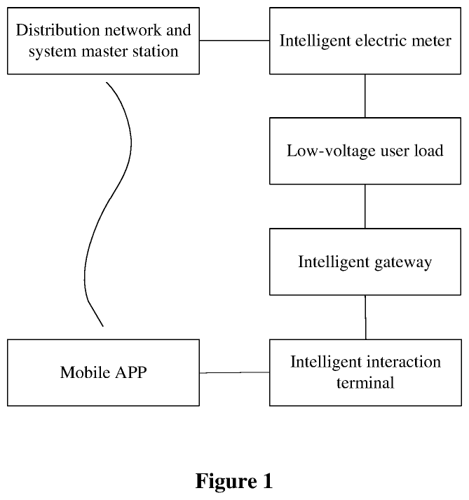

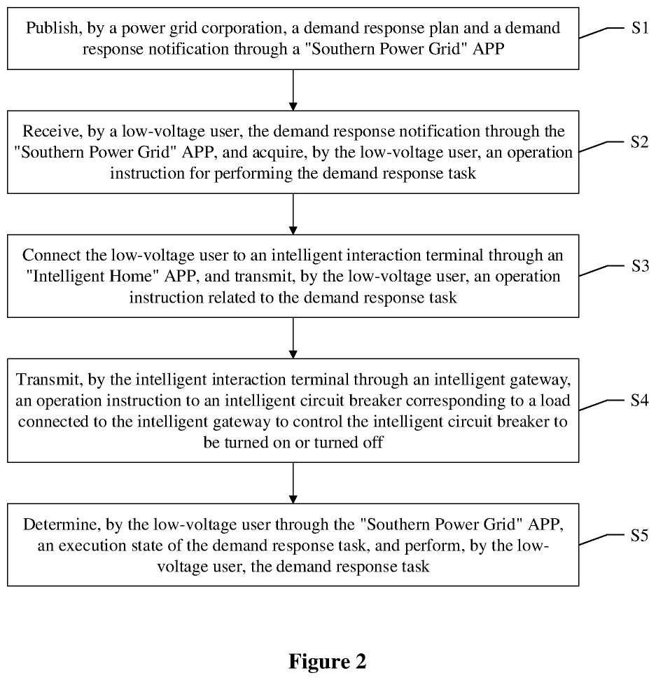

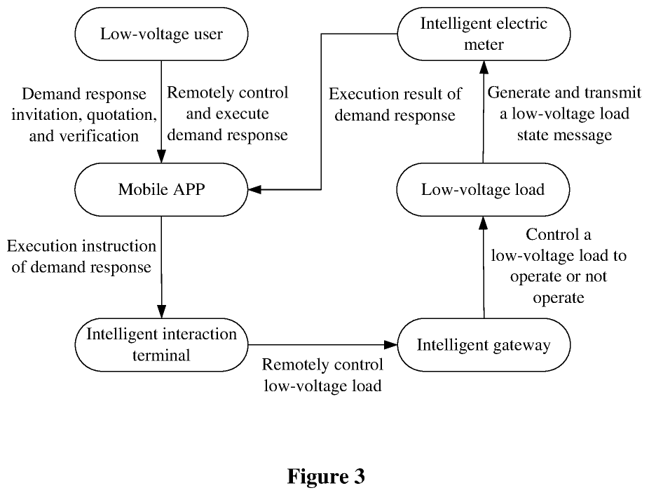

As shown in FIGS. 1 to 3, a response interaction system for intelligently interacting with a low-voltage user and a response interaction method for intelligently interacting with a low-voltage user are provided according to the embodiment. The response interaction system includes: a distribution network and system master station, an intelligent electric meter, a mobile APP, an intelligent interaction terminal, an intelligent gateway, and a low-voltage user load. The distribution network and system master station, the intelligent electric meter, the low-voltage user load, the intelligent gateway, the intelligent interaction terminal, and the mobile app are wirelessly connected in sequence. The distribution network and system master station is wirelessly connected to the mobile APP. The mobile APP includes, but is not limited to, a “Southern Power Grid” APP and an “Intelligent Home” APP. The “Intelligent Home” APP may be an applet embedded in the “Southern Power Grid” APP. The “Intelligent Home” APP includes, but is not limited to, a mature APP such as a “MiJia” APP and a “Huawei Smart Life”

APP.

The following information flows are transmitted in the response interaction system. Information flow 1 is transmitted between the low-voltage user and the mobile APP. The “Southern Power Grid” APP performs a demand response invitation, a quotation and verification, and the mobile APP remotely controls and executes the demand response. Information flow 2 is transmitted between the mobile APP and the intelligent interaction terminal. The “Intelligent Home” APP transmits an execution instruction for a demand response task to the intelligent interaction terminal. Information flow 3 is transmitted between the intelligent interaction terminal and the intelligent gateway. The intelligent interaction terminal remotely controls the low-voltage user load through the intelligent gateway. Information flow 4 is transmitted between the intelligent gateway and the low-voltage user load. The intelligent gateway transmits an instruction to control the low-voltage user load to operate or not operate. Information flow 5 is transmitted between the low-voltage user load and the intelligent electric meter. The intelligent electric meter acquires a state of the low-voltage user load that operates or does not operate, and generates and transmits a message. Information flow 6 is transmitted between the intelligent electric meter and the mobile APP. The intelligent electric meter transmits an execution result of the demand response task for the “Southern Power Grid” APP.

The distribution network and system master station and the mobile APP perform communication through a 4G/5G communication network, a private wireless network or a fiber optic private network; and the mobile APP and the intelligent interaction terminal, the intelligent interaction terminal and the intelligent gateway, and the intelligent gateway and the low-voltage user load respectively perform communication a Wi-Fi technology, a Bluetooth technology or a Zigbee technology.

The distribution network and system master station and the mobile APP, the mobile APP and the intelligent interaction terminal, the intelligent interaction terminal and the intelligent gateway, and the intelligent gateway and the low-voltage user load respectively perform communication with an encryption algorithm. A security protection mechanism is constructed by using an account password and a protocol encryption algorithm. An IP (Internet Protocol) address, a MAC (Media Access Control) address, a spectrum, an orientation, and an intensity feature of a communication link are analyzed, and a feature fingerprint of a legitimate intelligent home gateway is extracted by using a clustering analysis algorithm, to detect and identify an illegal communication link, ensuring the security of information transmission, and avoiding a large-scale power accident due to the erroneous operation on the demand response caused by network hijacking or information leakage.

The low-voltage user load includes, but is not limited to, a computer, an illuminating device, a water heater, an air conditioner, a sweeping machine, a washing machine, a dishwasher, and an electric vehicle.

A response interaction method for intelligently interacting with a low-voltage user is further provided according to the embodiment. The response interaction method includes a process of the low-voltage user participating in a demand response. The process of the low-voltage user participating in the demand response includes the following steps S1 to S5.

In step S1, the distribution network and system master station transmits a demand response plan and a demand response notification through the “Southern Power Grid” APP.

In step S2, the low-voltage user receives the demand response notification through the “Southern Power Grid” APP, and acquires an operation instruction for performing a demand response task.

In step S3, the low-voltage user is connected to the intelligent interaction terminal through the “Intelligent Home” APP, and transmits an operation instruction related to the demand response task.

In step S4, the intelligent interaction terminal transmits an operation instruction through an intelligent gateway to an intelligent circuit breaker corresponding to a load connected to the intelligent gateway to control the intelligent circuit breaker to be turned on or turned off.

In step S5, the low-voltage user determines an execution state of the demand response task through the “Southern Power Grid” APP, and performs the demand response task.

In the response interaction system for intelligently interacting with a low-voltage user according to the embodiment, the intelligent electric meter generates a message and transmits the message to the distribution network and system master station. The distribution network and system master station analyzes the message to acquire the execution state of the demand response task of the low-voltage user, and transmits an execution result of the demand response task through the mobile APP.

The intelligent electric meter transmits the message, and communicates and interacts with the distribution network and system master station in a power line communication manner.

Those skilled in the art can clearly understand that, for ease and simplicity of description, reference may be made to the foregoing embodiments of the method for operations of the system, apparatus and units, which are not repeated herein. The above embodiments are only used for illustrating the technical solutions of the present disclosure, and are not intended to limit the present disclosure. Although the present disclosure is illustrated in detail with reference to the embodiments described above, it should be understood by those skilled in the art that modification can be made to the technical solutions of the embodiments described above, or equivalent substitution can be made to a part of technical features of the technical solution. The modifications and equivalent substitution do not make the corresponding technical solutions deviate from the spirit and scope of the technical solutions of the embodiments of the present disclosure.

1. A response interaction system for intelligently interacting with a low-voltage user, comprising: a distribution network and system master station, an intelligent electric meter, a mobile APP (application), an intelligent interaction terminal, an intelligent gateway, and a low-voltage user load, wherein
the distribution network and system master station, the intelligent electric meter, the low-voltage user load, the intelligent gateway, the intelligent interaction terminal, and the mobile APP are wirelessly connected, and the distribution network and system master station is wirelessly connected to the mobile APP.

2. The response interaction system for intelligently interacting with a low-voltage user according to claim 1, wherein following information flows are transmitted in the response interaction system:
information flow 1 transmitted between the low-voltage user and the mobile APP, wherein the mobile APP is configured to perform a demand response invitation, a quotation and a verification, and remotely control and execute a demand response;
information flow 2 transmitted between the mobile APP and the intelligent interaction terminal, wherein the mobile APP is configured to transmit an execution instruction for a demand response task to the intelligent interaction terminal;
information flow 3 transmitted between the intelligent interaction terminal and the intelligent gateway, wherein the intelligent interaction terminal is configured to remotely control the low-voltage user load through the intelligent gateway;
information flow 4 transmitted between the intelligent gateway and the low-voltage user load, wherein the intelligent gateway is configured to transmit an instruction to control the low-voltage user load to operate or not operate;
information flow 5 transmitted between the low-voltage user load and the intelligent electric meter, wherein the intelligent electric meter is configured to acquire a state of the low-voltage user load that operates or does not operate, and then generate and transmit a message; and
information flow 6 transmitted between the intelligent electric meter and the mobile APP, wherein the intelligent electric meter is configured to transmit an execution result of the demand response task to the mobile APP.

3. The response interaction system for intelligently interacting with a low-voltage user according to claim 1, wherein
the distribution network and system master station and the mobile APP perform communication through a 4G/5G communication network, a private wireless network or a fiber optic private network; and
the mobile APP and the intelligent interaction terminal, the intelligent interaction terminal and the intelligent gateway, and the intelligent gateway and the low-voltage user load respectively perform communication based on a Wi-Fi technology, a Bluetooth technology or a Zigbee technology.

4. The response interaction system for intelligently interacting with a low-voltage user according to claim 3, wherein
the distribution network and system master station and the mobile APP, the mobile APP and the intelligent interaction terminal, the intelligent interaction terminal and the intelligent gateway, and the intelligent gateway and the low-voltage user load respectively perform communication with an encryption algorithm; and
according to the encryption algorithm, a security protection mechanism is constructed by using an account password and a protocol encryption algorithm, an IP address, a MAC address, a spectrum, an orientation and an intensity feature of a communication link are analyzed, and a feature fingerprint of a legitimate intelligent home gateway is extracted by using a clustering analysis algorithm, to detect and identify an illegal communication link.

5. The response interaction system for intelligently interacting with a low-voltage user according to claim 1, wherein the low-voltage user load is one or a combination of a computer, an illuminating device, a water heater, an air conditioner, a sweeping machine, a washing machine, a dishwasher, and an electric vehicle.

6. A response interaction method for intelligently interacting with a low-voltage user, comprising a process of the low-voltage user participating in a demand response, wherein the process of the low-voltage user participating in the demand response comprises:
step S1, transmitting, by a distribution network and system master station, a demand response plan and a demand response notification through a mobile APP (application);
step S2, receiving, by the low-voltage user, the demand response notification through the mobile APP, and acquiring, by the low-voltage user, an operation guide for performing a demand response task;
step S3, connecting the low-voltage user to an intelligent interaction terminal through the mobile APP, and transmitting, by the low-voltage user, an operation instruction related to the demand response task;
step S4, transmitting, by the intelligent interaction terminal through an intelligent gateway, an operation instruction to an intelligent circuit breaker corresponding to a load connected to the intelligent gateway to control the intelligent circuit breaker to be turned on or turned off; and
step S5, determining, by the low-voltage user through the mobile APP, an execution state of the demand response task, and performing, by the low-voltage user, the demand response task.

7. The response interaction method for intelligently interacting with a low-voltage user according to claim 6, wherein an intelligent electric meter generates a message and transmits the message to the distribution network and system master station, the distribution network and system master station analyzing the message to acquire the execution state of the demand response task of the low-voltage user, and transmits an execution result of the demand response task through the mobile APP.

8. The response interaction method for intelligently interacting with a low-voltage user according to claim 7, wherein the intelligent electric meter transmits the message, and communicates and interacts with the distribution network and system master station in a power line communication manner.
